(19) United States
(12) Patent Application Publication
(10) Pub. No.: US 2016/0188032 A1
(43) Pub. Date: Jun. 30, 2016

(54) TOUCH PANEL CAPABLE OF IDENTIFYING FINGERPRINT

(71) Applicant: Chih-Chung Lin, Taipei City (TW)

(72) Inventor: Chih-Chung Lin, Taipei City (TW)

(21) Appl. No.: 14/583,109

(22) Filed: Dec. 25, 2014

(51) Int. Cl. G06F 3/044; G06K 9/00; G06F 3/041

(52) U.S. Cl. CPC G06F 3/044; G06F 3/0416; G06K 9/0002; G06F 2203/04112

(57) ABSTRACT

A touch panel capable of identifying fingerprints includes a glass substrate, an electrode layer, a first and a second insulating layer, and a fingerprint identification sensing layer. The glass substrate has a first side and an opposite second side. The electrode layer is disposed on the second side, and has a plurality of first electrodes, second electrodes and metal trace lines electrically connected to the first and second electrodes. The first insulating layer fills spaces existing between the first and the second electrodes, whereas the second insulating layer covers the electrode layer. The fingerprint identification sensing layer is provided on the second insulating layer, and has a plurality of fingerprint identification chips and transmission conductors electrically connected to the fingerprint identification chips. By integrating the fingerprint identification chips into the touch panel, the touch panel can be produced at largely reduced manufacturing cost and provides upgraded fingerprint identification accuracy.

### FIELD OF THE INVENTION

The present invention relates to a touch panel capable of identifying fingerprints, and more specifically, to a touch panel that has fingerprint identification chips integrated thereinto to enable identification of fingerprints.

### BACKGROUND OF THE INVENTION

As the advancement of multimedia technology, more and more smart-type portable devices, such as mobile phones, personal digital assistants (PDAs), digital cameras (DCs), notebook computers, tablet computers and wearable devices, have become indispensable to people in their daily life. These portable devices are usually used to store highly personal and private data, such as telephone directory, photos and so on. In the event such a portable device is lost or stolen, the personal and private data stored therein are very possibly be used by other unauthorized people to cause unnecessary losses to the device owner.

Therefore, certain identity authentication and authorization management are required for these types of portable devices to ensure protection of users' privacy. One of the currently available major ways of identity authentication is password protection. Only after entering a correct password, the user can use and control the portable device. However, password protection cannot offer sufficient data security, because the password is easily leaked or cracked. Also, it is troublesome if the user forgot the password. Hence, portable electronic devices using fingerprint identification for identity authentication have been developed. Since a person's fingerprints are unique, the use of these unique fingerprints as a way of identity authentication can provide much higher security and is more convenient for use because the fingerprints save users the trouble of remembering and entering the password.

The currently available fingerprint identification systems have been widely applied to hand-held devices or mobile devices. In most cases, the fingerprint identification device is separately provided on a fixed side of the keyboard of a notebook computer or at a fixed position on the back side or the bottom side of a hand-held mobile device without being effectively integrated into a touch screen of the hand-held mobile device to reduce the volume thereof. Furthermore, the conventional fingerprint identification chip package module includes a substrate, a chip, and a molded sealing body. The chip is mounted on and electrically connected to the substrate and the molded sealing body covers a surface of the substrate and the chip.

Since the chip is covered by multiple layers of materials, the final chip package module is relatively thick and has relatively low sensitivity when a sensing area of the chip is touched by a finger.

Furthermore, the conventional slide-sensing fingerprint identification system is directional. It must be separately mounted and requires a lot of time to complete the fingerprint identification, and is therefore poor in terms of structural integration and convenience in use.

### SUMMARY OF THE INVENTION

To solve the above problems, a primary object of the present invention is to provide a touch panel capable of identifying fingerprints, which has fingerprint identification chips integrated thereinto.

To achieve the above and other objects, the touch panel according to the present invention includes a glass substrate, an electrode layer, a first and a second insulating layer, and a fingerprint identification sensing layer.

The glass substrate has a first and an opposite second side, and the first side defines a touch zone and a non-touch zone located around the touch zone. The electrode layer is disposed on the second side, and has a plurality of first electrodes, second electrodes, and metal trace lines electrically connected to the first and second electrodes. The first insulating layer fills spaces existing between the first and the second electrodes, whereas the second insulating layer covers the electrode layer. The fingerprint identification sensing layer is provided on the second insulating layer, and has a plurality of fingerprint identification chips and transmission conductors electrically connected to the fingerprint identification chips By integrating the fingerprint identification chips into the touch panel, the touch panel can be produced at largely reduced manufacturing cost and provides upgraded fingerprint identification sensitivity and accuracy.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a touch panel capable of identifying fingerprints according to a first preferred embodiment of the present invention;

FIG. 2 is a fragmentary, assembled sectional view of the touch panel capable of identifying fingerprints according to the first preferred embodiment of the present invention;

FIG. 3 is a fragmentary, assembled sectional view of the touch panel capable of identifying fingerprints according to a second preferred embodiment of the present invention;

FIG. 4 is a fragmentary, assembled sectional view of the touch panel capable of identifying fingerprints according to a third preferred embodiment of the present invention;

FIG. 5 is a top view of the touch panel capable of identifying fingerprints according to a fourth preferred embodiment of the present invention; and

FIG. 5a is an enlarged view of the circled area of FIG. 5.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

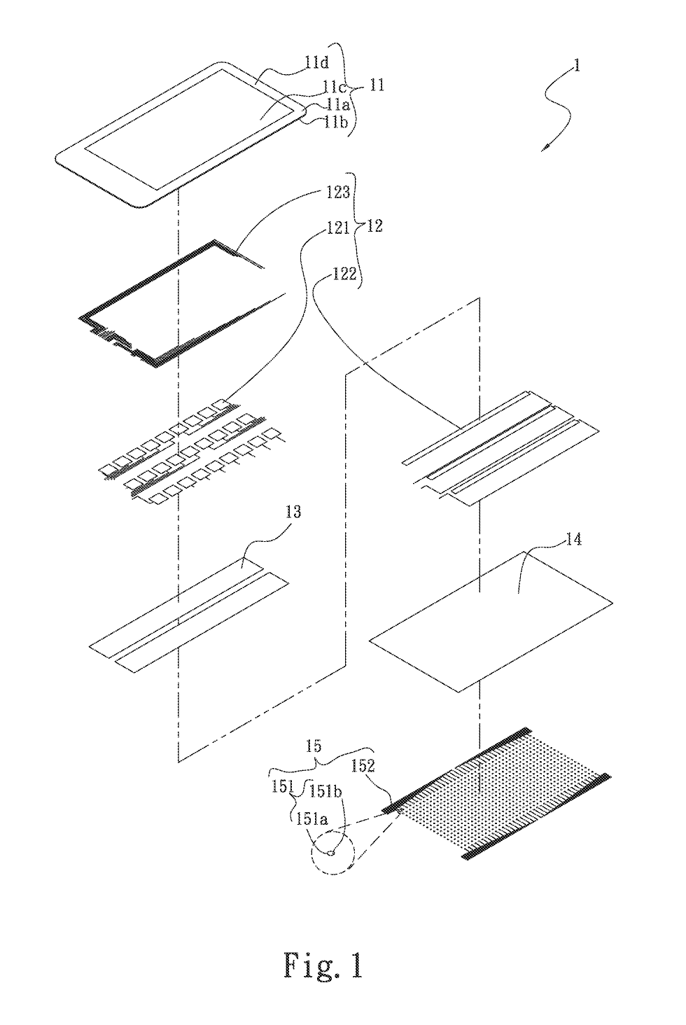

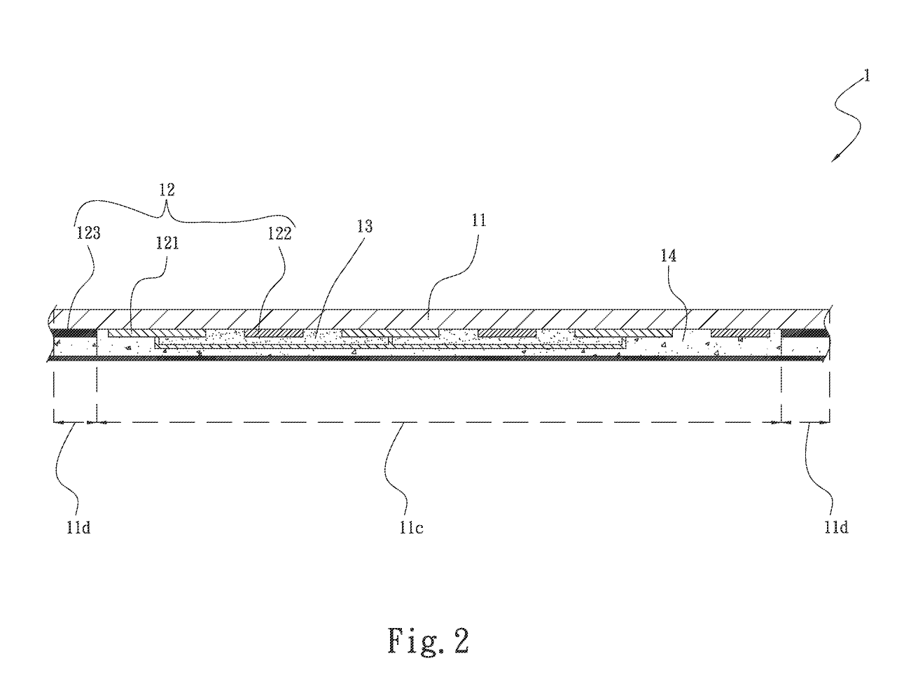

Please refer to FIG. 1, which is an exploded perspective view of a touch panel capable of identifying fingerprints according to a first preferred embodiment of the present invention, and to FIG. 2, which is a fragmentary, assembled sectional view of the touch panel capable of identifying fingerprints according to the first preferred embodiment of the present invention. For the purpose of conciseness, the present invention is also briefly referred to as the touch panel and generally denoted by reference numeral 1 herein. As shown, the touch panel 1 includes a glass substrate 11, an electrode layer 12, a first and a second insulating layer 13, 14, and a fingerprint identification sensing layer 15.

The glass substrate 11 has a first and an opposite second side 11a, 11b respectively forming an upper and a lower side thereof. The first side 11a defines a touch zone 11c and a non-touch zone 11d, which is located adjacent to the touch zone 11c to surround a periphery of the touch zone 11c.

The electrode layer 12 is disposed on the second side 11b of the glass substrate 11, and has a plurality of first and second electrodes 121, 122 and a plurality of metal trace lines 123, to which the first and second electrodes 121, 122 are electrically connected. The metal trace lines 123 are located on the second side 11b of the glass substrate 11 corresponding to the non-touch zone 11d.

The first insulating layer 13 is located below the first and the second electrodes 121, 122 to cover the same and fill spaces existing therebetween. Some of the first and the second electrodes 121, 122 overlap one another, but the first insulating layer 13 filling the spaces between the first and the second electrodes 121, 122 allows the first or the second electrodes 121, 122 to successfully extend across the second or the first electrodes 122, 121.

The second insulating layer 14 is located below the electrode layer 12 to completely cover the first and the second electrodes 121, 122, the first insulating layer 13 and the metal trace lines 123 to provide absolute insulation effect.

The fingerprint identification sensing layer 15 is provided on the second insulating layer 14, and has a plurality of fingerprint identification chips 151 and transmission conductors 152, to which the fingerprint identification chips 151 are electrically connected. Each of the fingerprint identification chips 151 has a sensing area 151a and a top side 151b, on which the sensing area 151 is formed.

The present invention is characterized in that the fingerprint identification chips 151 of the fingerprint identification sensing layer 15 and the electrode layer 12 are integrated into the touch zone 11c, such that the touch panel 1 can be produced at largely reduced manufacturing cost and provides upgraded fingerprint identification accuracy.

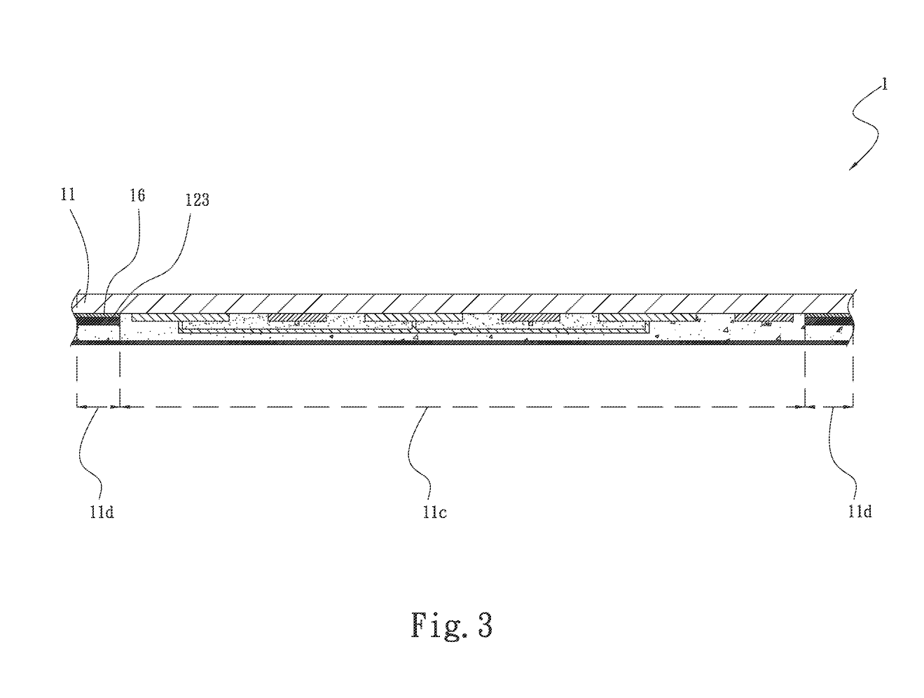

Please refer to FIG. 3, which is a fragmentary, assembled sectional view of the touch panel 1 according to a second preferred embodiment of the present invention. As shown, the second embodiment of the touch panel 1 is generally structurally similar to the first embodiment except that, in this second embodiment, the touch panel 1 further includes a shielding layer 16, which is provided on the second side 11d of the glass substrate 11 corresponding to the non-touch zone 11b and is located between the glass substrate 11 and the metal trace lines 123 to prevent the metal trace lines 123 from being exposed to external environment.

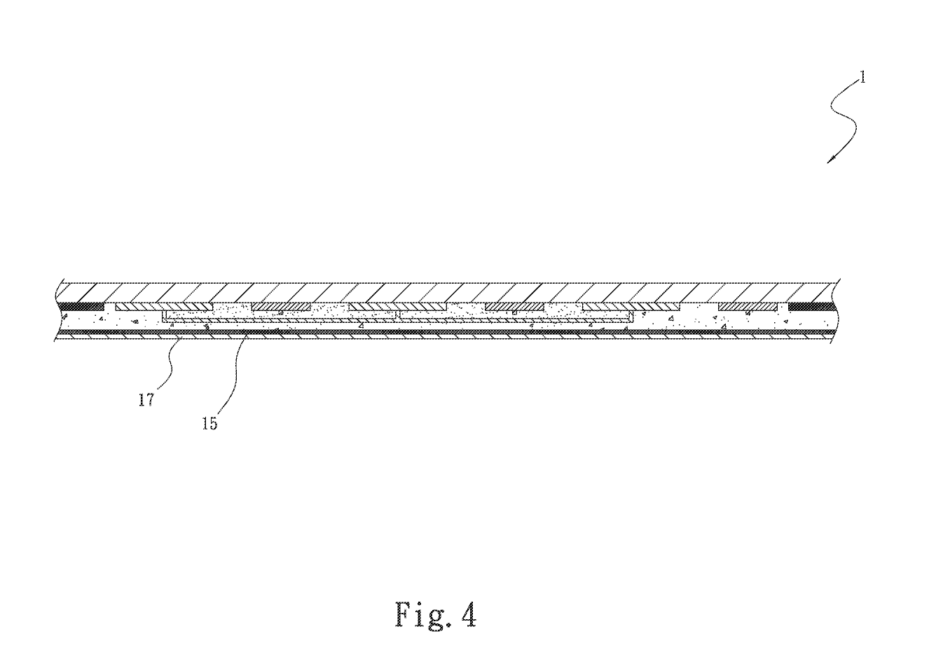

Please refer to FIG. 4, which is a fragmentary, assembled sectional view of the touch panel 1 according to a third preferred embodiment of the present invention. As shown, the third embodiment of the touch panel 1 is generally structurally similar to the first embodiment except that, in this third embodiment, the touch panel 1 further includes a protective layer 17 for covering the fingerprint identification sensing layer 15, so as to prevent a back side of the fingerprint identification sensing layer 15 from being exposed to external environment. The protective layer 17 is made of epoxy resin, acrylic resin or silica gel.

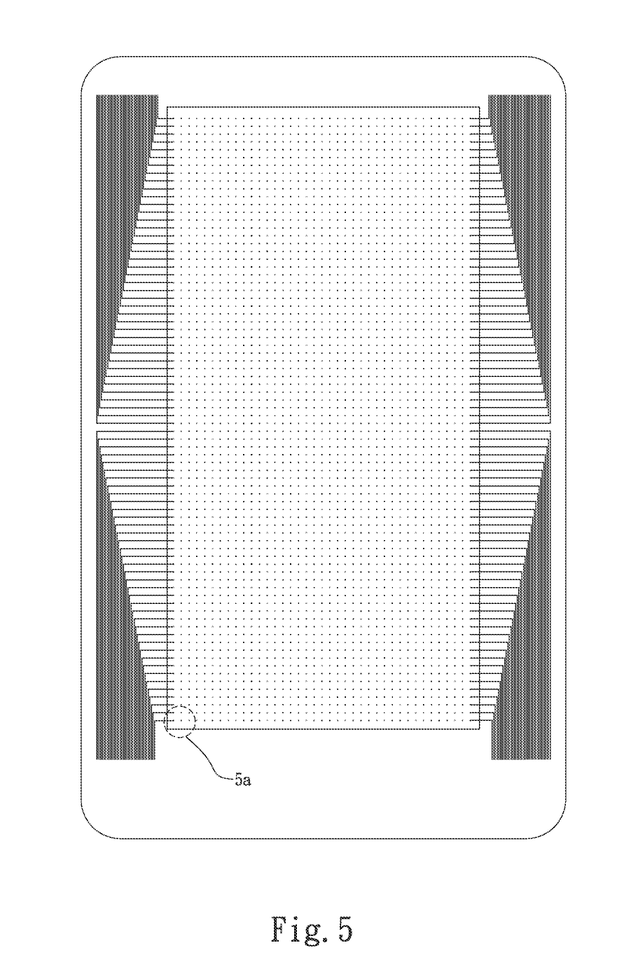

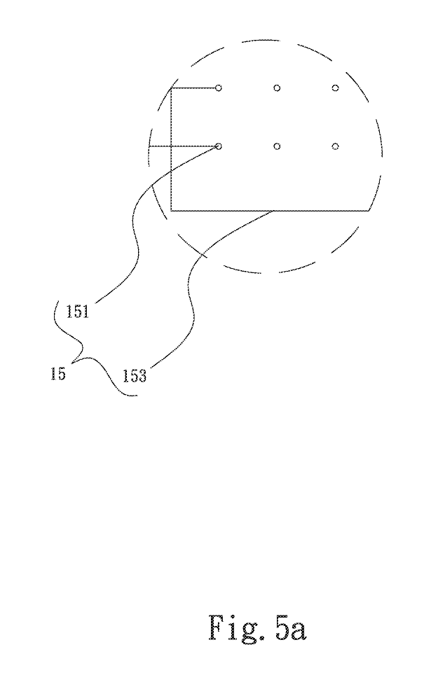

Please refer to FIG. 5, which is a top view of the touch panel 1 according to a fourth preferred embodiment of the present invention, and to FIG. 5a, which is an enlarged view of the circled area of FIG. 5. As shown, the fourth embodiment of the touch panel 1 is generally structurally similar to the first embodiment except that, in this fourth embodiment, the touch panel 1 further includes a plurality of metal conductors 153, which are transparent and located adjacent to the fingerprint identification chips 151, such that the fingerprint identification chips 151 can have enhanced fingerprint identification accuracy.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A touch panel capable of identifying fingerprints, comprising:
a glass substrate having a first side and an opposite second side respectively forming an upper and a lower side thereof; and the first side defining a touch and a non-touch zone, and the non-touch zone being locate adjacent to the touch zone;
an electrode layer being disposed on the second side of the glass substrate and having a plurality of first and second electrodes and a plurality of metal trace lines, and the first and the second electrodes being electrically connected to the metal trace lines;
a first insulating layer filling spaces existing between the first and the second electrodes;
a second insulating layer covering the electrode layer; and
a fingerprint identification sensing layer being provided on the second insulating layer, and having a plurality of fingerprint identification chips and a plurality of transmission conductors; and the fingerprint identification chips being electrically connected to the transmission conductors.

2. The touch panel as claimed in claim 1, wherein each of the fingerprint identification chips has a sensing area and a top side, and the sensing area being formed on the top side.

3. The touch panel as claimed in claim 1, further comprising a shielding layer, which is provided on the second side of the glass substrate corresponding to the non-touch zone and located between the glass substrate and the metal trace lines.

4. The touch panel as claimed in claim 1, further comprising a protective layer, which covers the fingerprint identification sensing layer and is made of a material selected from the group consisting of epoxy resin, acrylic resin, and silica gel.

5. The touch panel as claimed in claim 1, wherein the metal trace lines are located corresponding to the non-touch zone.

6. The touch panel as claimed in claim 1, wherein the fingerprint identification sensing layer further includes a plurality of metal conductors; and the metal conductors being transparent and located adjacent to the fingerprint identification chips.

7. The touch panel as claimed in claim 1, wherein the non-touch zone is located around a periphery of the touch zone.
